(19) United States
(12) Patent Application Publication
(10) Pub. No.: US 2014/0287188 A1
(43) Pub. Date: Sep. 25, 2014

(54) STRETCHED STRUCTURE OF A STRETCHED MEMBER

(71) Applicant: Okamura Corporation, Kanagawa (JP)

(72) Inventors: Shinya Naitou, Kanagawa (JP); Syouichi Izawa, Tokyo (JP)

(21) Appl. No.: 14/354,798

(22) PCT Filed: Oct. 25, 2012
(86) PCT No.: PCT/JP2012/077564

§ 371 Date: Apr. 28, 2014

(30) Foreign Application Priority Data
Oct. 28, 2011 (JP) 2011-237834

(51) Int. Cl. A47C 31/02; B68G 7/05

(52) U.S. Cl. CPC A47C 31/02; B68G 7/05
USPC 428/99; 428/124

(57) ABSTRACT

Provided is a stretching structure for stretched member, whereby a frame can be manufactured inexpensively without the use of complex and expensive dies, and a stretched material having an attractive external appearance, particularly the external appearance in back view and side view, is obtained through a simple stretching operation. In a stretching structure for a stretched member (28) stretched onto a back frame (27) serving as the frame, the back frame (27) is equipped with a main frame member (32), the surface of which abuts the stretched member (28); and an upper auxiliary frame member (33) fastened to the back surface of at least a portion of the main frame member (32). The stretched member (28) is looped in succession about the outside peripheral surface of the main frame member (32) from the front side, and along the outside peripheral surface, the back surface, and the inside peripheral surface of the upper auxiliary frame member (33), affixing the outside peripheral edge portion of the stretched member (28) to the upper auxiliary frame member (33) at the surface thereof opposing the back surface of the main frame member (32).

### TECHNICAL FIELD

The present invention relates to the stretched structure of a stretched member that applies to the backrest, a seat, a headrest, a mesh-stretched screen or a partition.

### BACKGROUND OF THE INVENTION

In Patent Literature 1, as the stretched structure of a stretched member in the backrest of a chair, a pair of edge portions which faces each other of the stretched member is wound from the front surface of a pair of frame rods which face each other in a frame to the back surface over the outer side edge. An edge member having a hook at the end engages with a corner between the inner side surface and the front surface of the frame rod. The stretched member is stretched over the frame. The edge member mounted to another pair of edge portions of the stretched member engages in a groove on the outer circumferential surface of another pair of frame rods of the frame.

In Patent Literature 2, there is formed a groove which is open backward at the front part of the outer circumferential surface of a frame, and the edge of a stretched member and an edge member mounted thereto engage in the groove.

Furthermore, various groove members and projection members fixed to the circumferential edge of a membrane member engage in projections member and groove members on the back surface of a frame-like support member in FIGS. 12 and 13 of Patent Literature 3.

### PRIOR ART

### Patent Literatures

### Patent Literature 1: JP4652767B2

### Patent Literature 2: JP2011-161049A

### Patent Literature 3: JP2002-240081A

### SUMMARY OF THE INVENTION

### Problems to be Solved by the Invention

In Patent Literature 1, the edge member mounted to the edge of the stretched material has to be shaped like a hook, and its manufacturing is complicated. It is troublesome to engage the hook-like edge member to the inner side surface and front surface of the frame.

In the edge member mounted to the edge portion of the stretched member to the groove on the outer circumferential surface of the frame in Patent Literature 1, and those in Patent Literature 2, the part in front of the groove on the outer circumferential surface of the frame is covered with the stretched member and the part behind the groove is exposed to the outside. The side of the backrest is divided into two and provides bad appearance.

In Patent Literature 3, the groove member and projection member are exposed to the back surface of the backrest and provide bad appearance.

To improve the appearance of the back surface of the backrest, a groove is formed on the inner circumferential surface of the frame, and the end of the stretched material and the edge member mounted thereto wound on the front surface, the outer circumferential surface, the back surface and the inner circumferential surface of the frame in order may preferably engage in the groove. To form the groove on the inner circumferential surface of the synthetic-resin frame, in casting, a core for forming the groove has to pass through inward of a die for forming the frame and a molding die becomes complicated.

In view of the disadvantages in the prior art, it is an object of the invention to provide the stretched structure of a stretched member that can be manufactured at low cost without an expensive complicated die, and has a good appearance especially vile wed from back and side, wherein the stretched member is easily stretched over a frame.

### Means for Solving the Problems

According to the present invention, the foregoing problems are solved as below:

(1) In the stretched structure of a stretched member that is stretched over a front surface of a frame, the frame comprises a main frame member in which the stretched member is in contact with the front surface of the main frame member and an auxiliary frame member fixed to a back surface of at least part of the main frame member, the stretched member being wound on from the front surface to an outer circumferential surface of the main frame member, and on an outer circumferential surface, a back surface and an inner circumferential surface portion of the auxiliary frame member in order, an circumferential edge of the stretched member being mounted to a front surface of the auxiliary frame member which faces the back surface of the main frame member.

By the structure, the stretched member all covers the front surface to the outer circumferential surface of the main frame member and the outer circumferential surface, the back surface and the inner circumferential surface of the auxiliary frame member thereby providing good appearance.

When the circumferential edge portion of the stretched member is mounted to the front surface of the auxiliary frame member, the auxiliary frame member is fixed to the back surface of the main frame member. Thereafter, the stretched member is wound on from the inner circumferential surface, the back surface to the outer circumferential surface and the outer circumferential surface and the front surface of the main frame member in order, and the other circumferential edge portion is mounted to the frame with another mounting means, thereby stretching the stretched member to the frame easily.

It is not necessary to form the groove on the inner circumferential surface of the frame with an expensive complicated die thereby manufacturing the frame at low cost.

(2) In the item (1), a rigid edge member is mounted to the circumferential edge of the stretched member, the edge member being mounted with the circumferential edge portion to the front surface of the auxiliary frame member which faces the back surface of the main frame member.

By the structure, the circumferential edge portion of the stretched member can be mounted over the front surface of the auxiliary frame member easily and readily.

(3) In the item (3), there is formed a projection on one of the front surface of the auxiliary frame member and the edge member which faces the front surface of the auxiliary frame member and a groove which engages with the projection to prevent positional displacement of the edge member to the auxiliary frame member on the other of the front surface of the auxiliary frame member and the edge member.

By the structure, the edge portion of the stretched member can easily be positioned over the front surface of the auxiliary frame member, thereby preventing the edge portion of the stretched member from displacing with respect to the auxiliary frame member.

(4) In the item (3), the projection on the front surface of the auxiliary frame member engages in the hole of the edge member and also in the groove on the back surface of the main frame member thereby preventing positional displacement of the auxiliary frame member, edge member and main frame member.

The simple structure prevents positional displacement between the auxiliary frame member, edge member and main frame member securely.

(5) In the item (1), there is formed a recessed step which is recessed backward and is open inward on the front surface of the auxiliary frame member which faces the back surface of the main frame member, a circumferential edge portion of the stretched member or the edge member mounted thereto engaging in the recessed step.

When the auxiliary frame member is fixed to the back surface of the main frame member, the recessed step becomes a groove formed on the inner circumferential surface of the frame. The circumferential edge portion of the stretched member or the edge member mounted thereto engage in the groove. To form the groove, it is not necessary to use an expensive complicated die as above, thereby reducing manufacturing cost.

(6) In the item (1), the auxiliary frame member is fixed to the main frame member with a screw which passes through from the front surface to the back surface of the main frame member, a head of the screw being covered with the stretched member stretched over the front surface of the main frame member.

The auxiliary frame member can easily be fixed to the main frame member and the head of the screw is covered with the stretched member without external exposure thereby providing good appearance.

In wasting a tool is thrust into the stretched member from front, and the screw is removed. The edge portion of the stretched member is removed from the main frame member with the auxiliary frame member, and each member can be separated and wasted.

### Advantages of the Invention

According to the present invention, there is provided the stretched structure of a stretched member, in which a frame can be manufactured at low cost, wherein its appearance, particularly viewed from back and side, is good and the stretched member can easily be stretched over the frame.

### BRIEF DESCRIPTION OF THE DRAWINGS

FIG. 1 is a front elevational view of a chair comprising the backrest to which the stretched structure of a stretched member according to the present invention applies;

FIG. 2 is a side view thereof;

FIG. 3 is an exploded perspective view of the backrest and a support frame therefor;

FIG. 4 is a front elevational view of the backrest and support frame from which the stretched member is omitted;

FIG. 5 is a vertical sectional view taken along the line V-V in FIG. 4;

FIG. 8 is a vertical sectional view taken along the line VI-VI in FIG. 4;

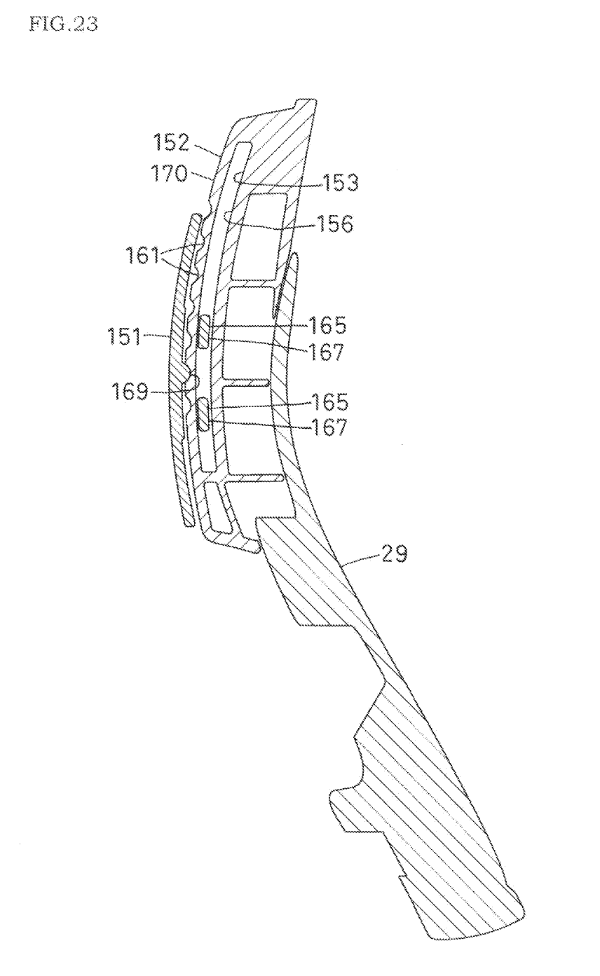

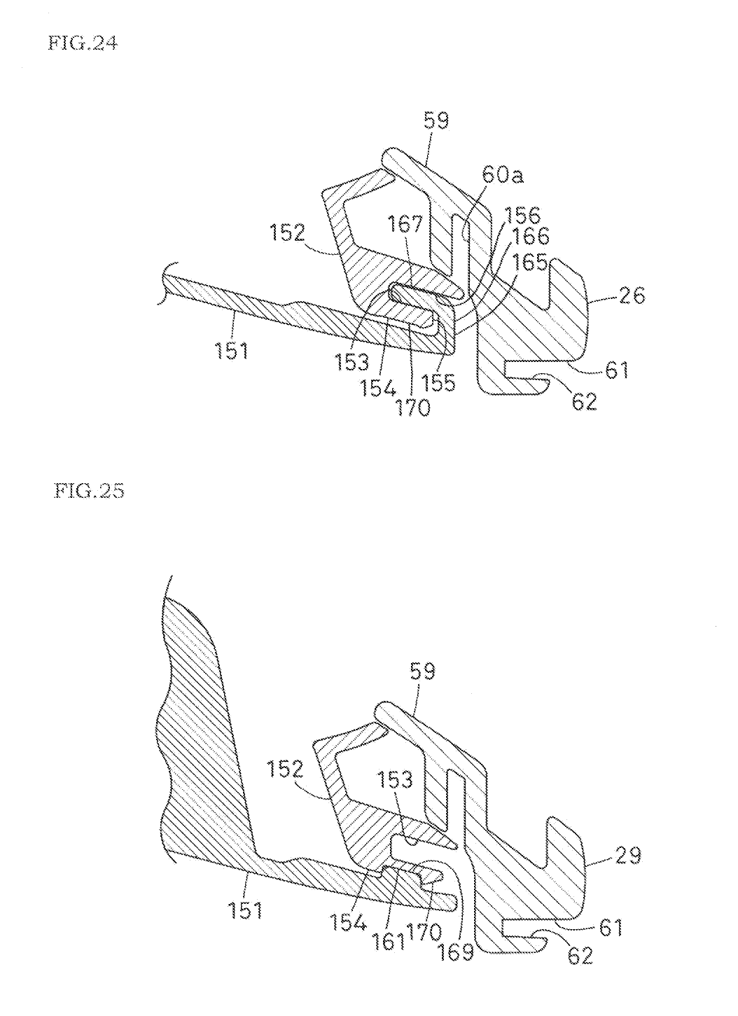

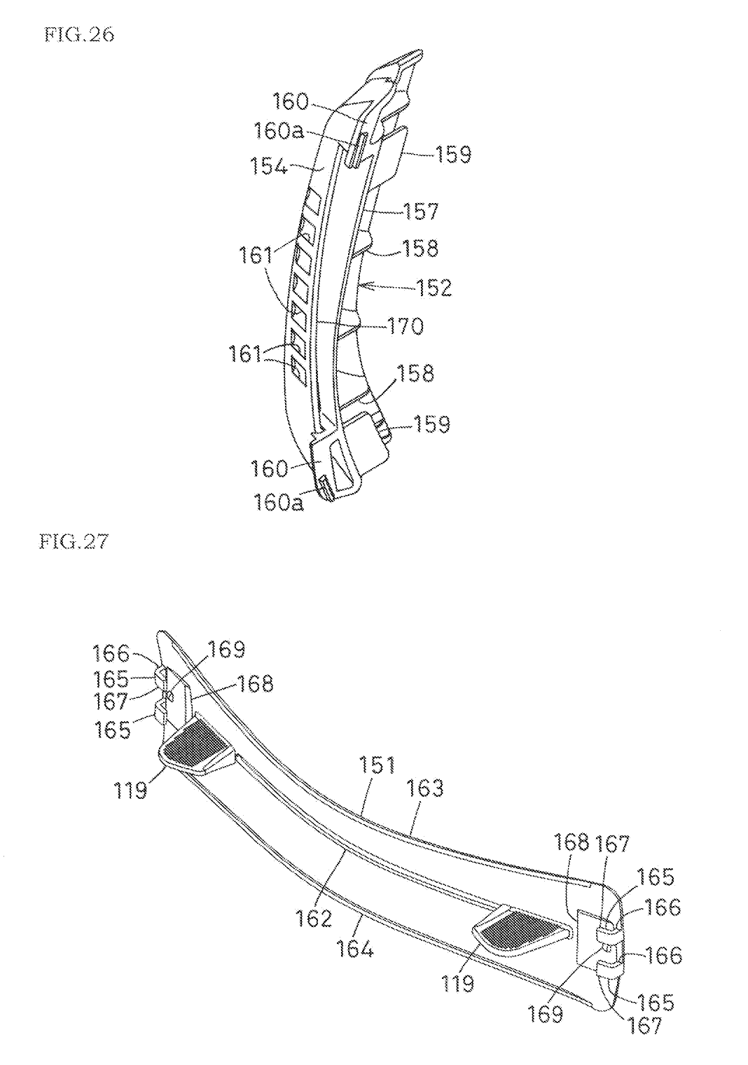

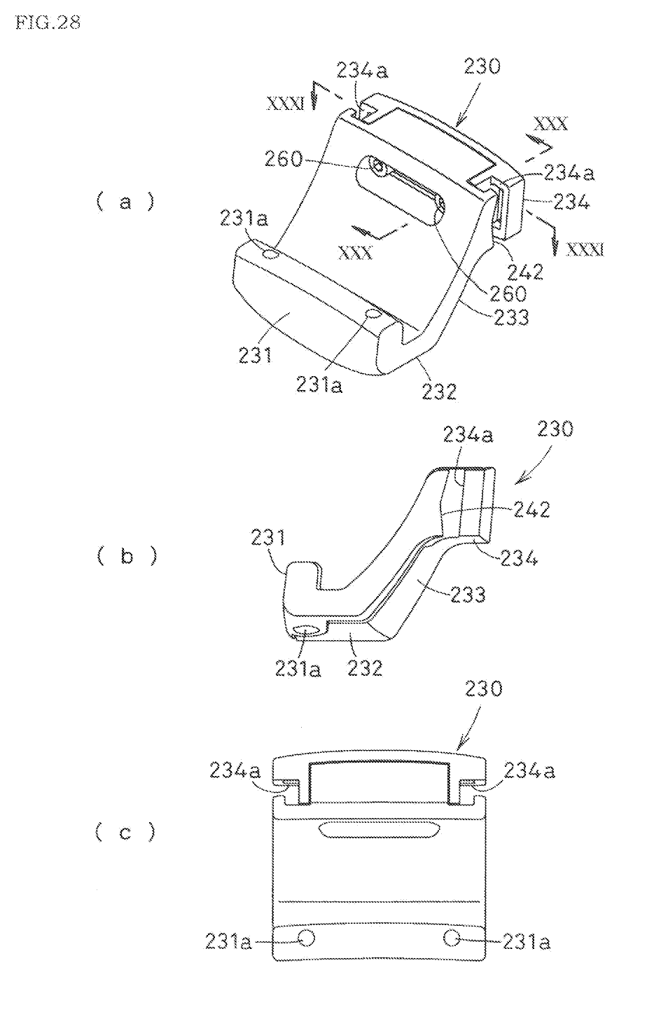

FIG. 7 is a sectional view taken along the line VII-VII in FIG. 5;

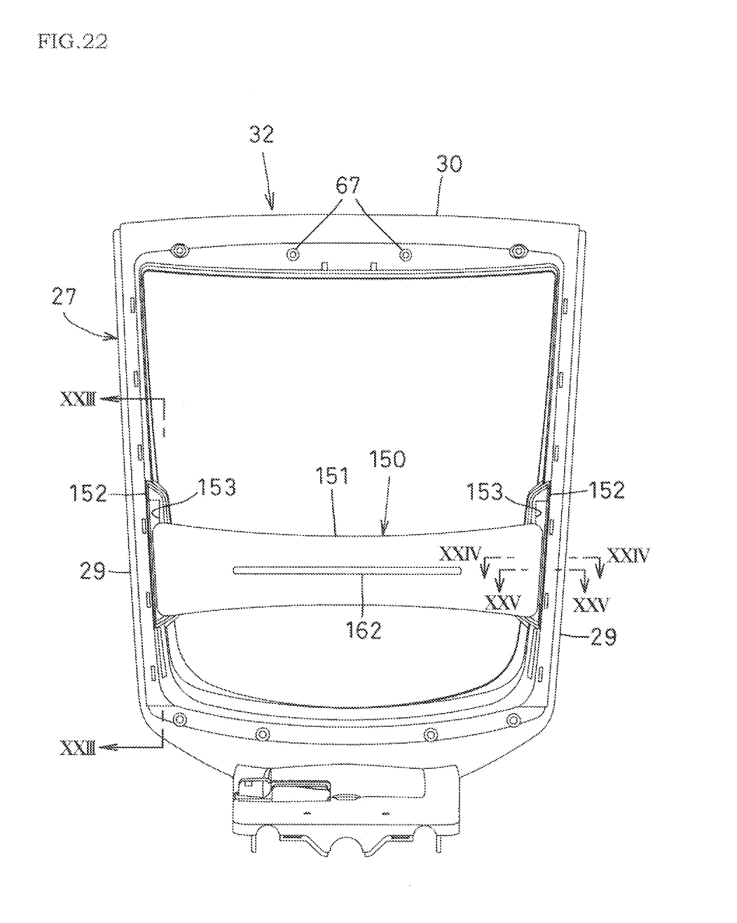

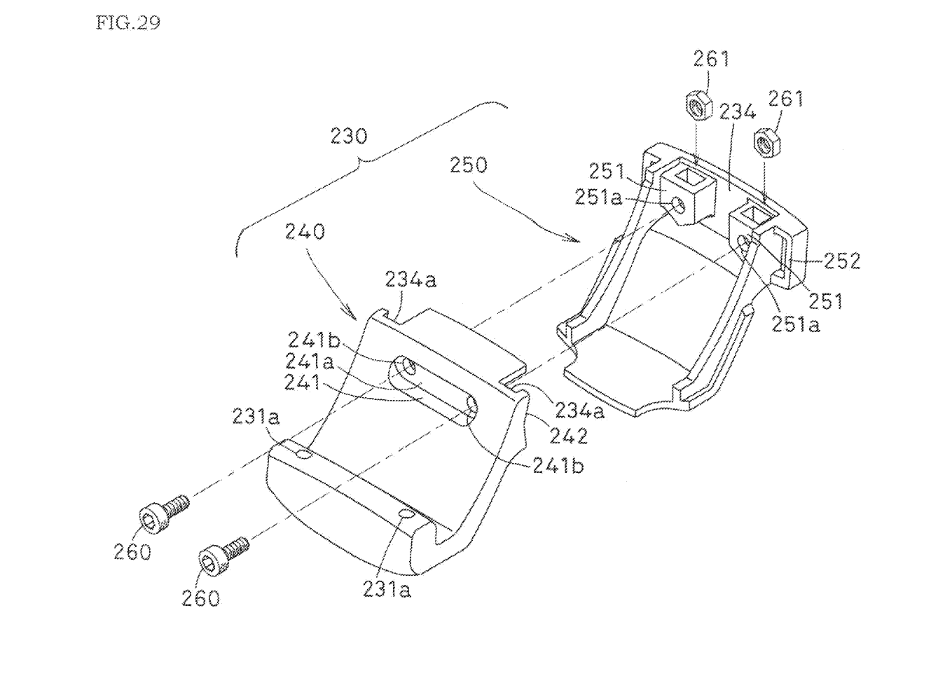

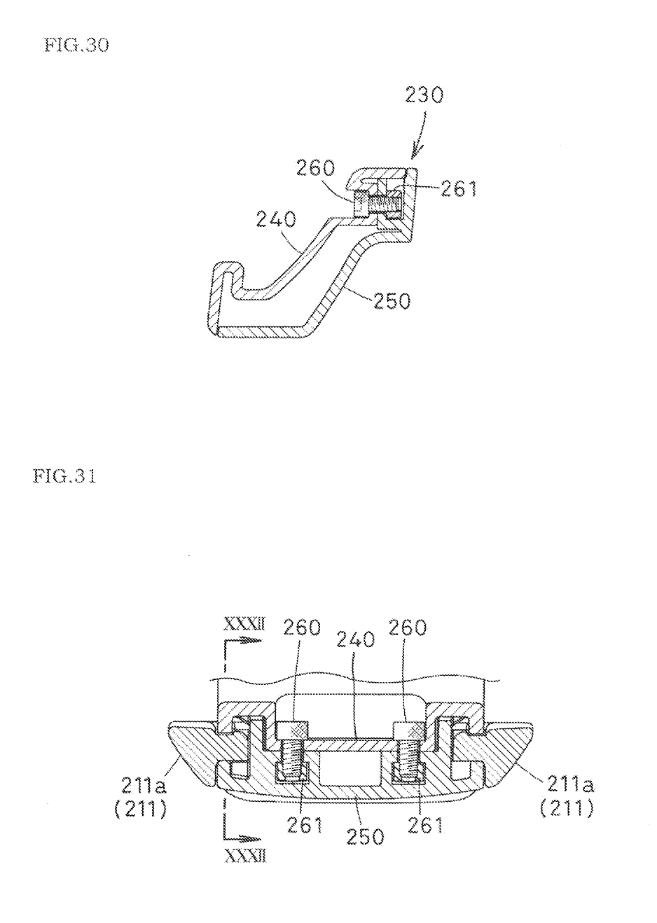

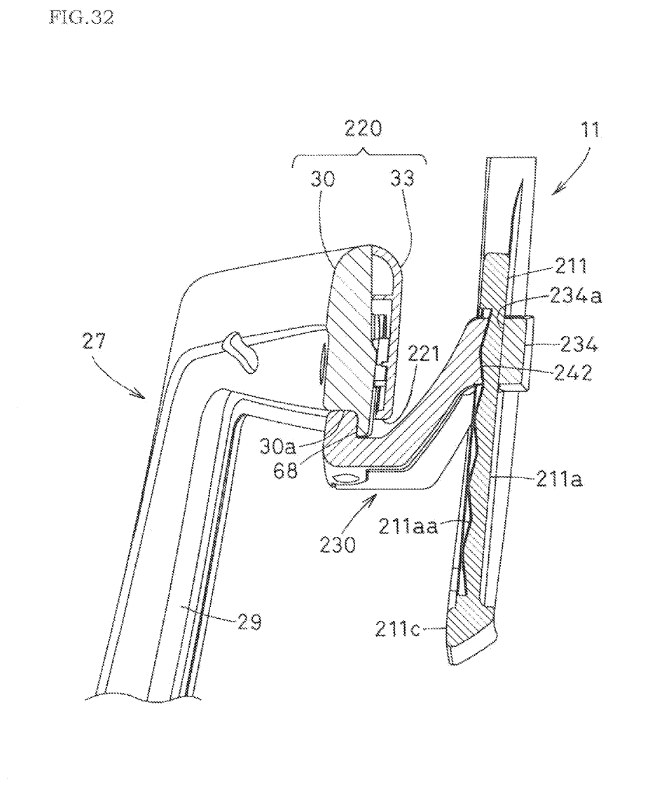

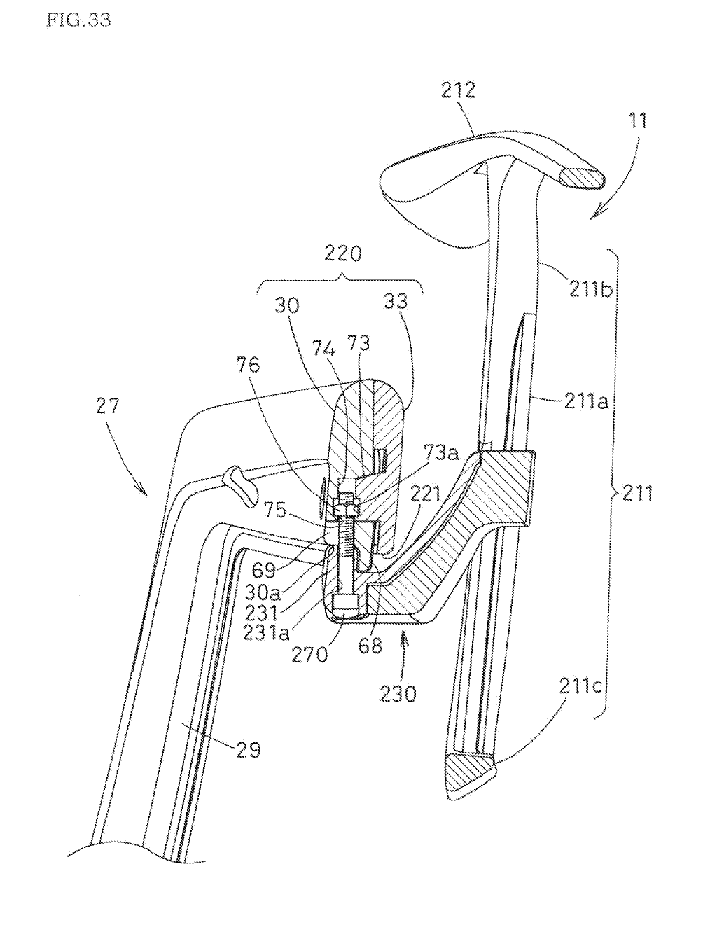

FIG. 8 is a view seen in a direction of arrows VIII-VIII in FIG. 4;

FIG. 9 is a sectional view taken along the line IX-IX in FIG. 8;

FIG. 10 is a sectional view taken along the line X-X In FIG. 8;

FIG. 11 is a sectional view taken along the line XI-XI in FIG. 8;

FIG. 12 is an exploded perspective view of an upper part of a main frame member and an upper auxiliary frame member;

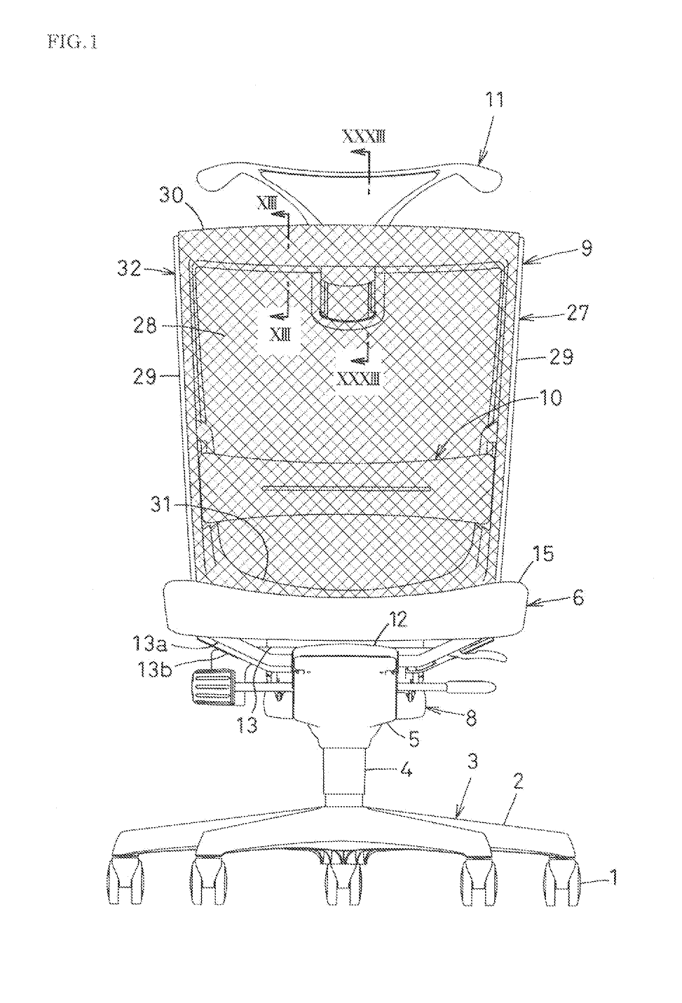

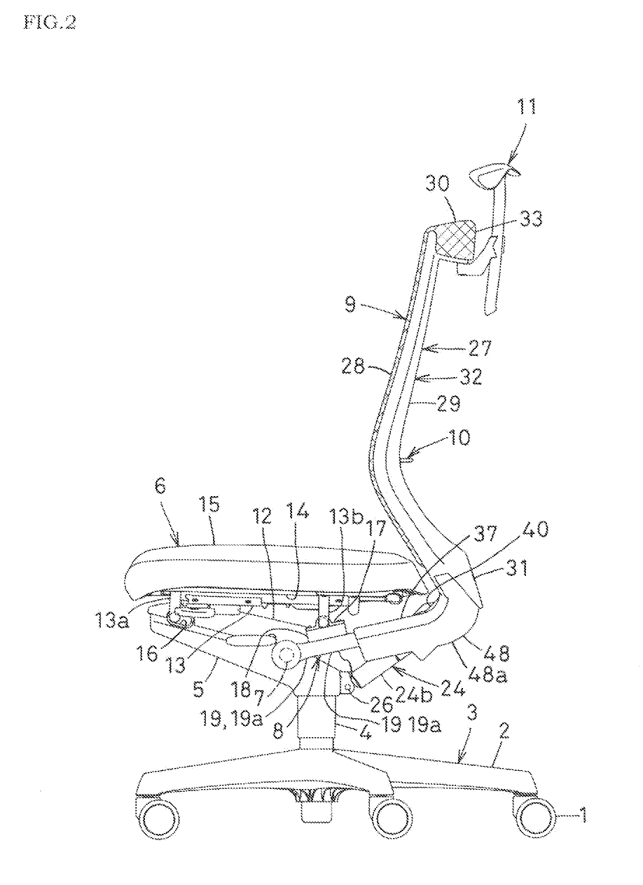

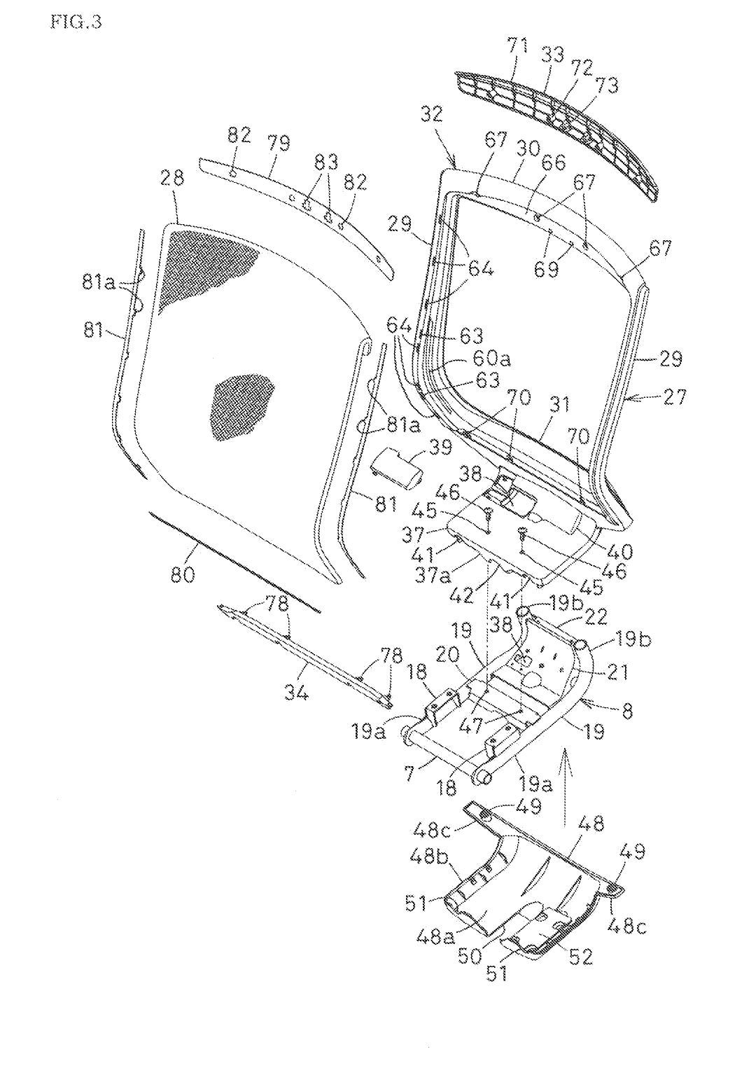

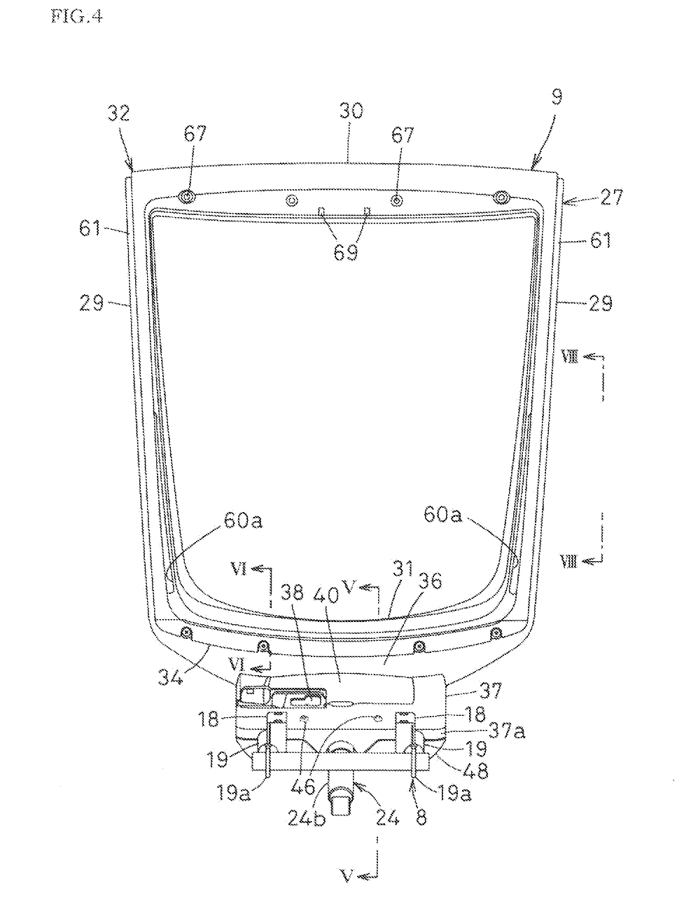

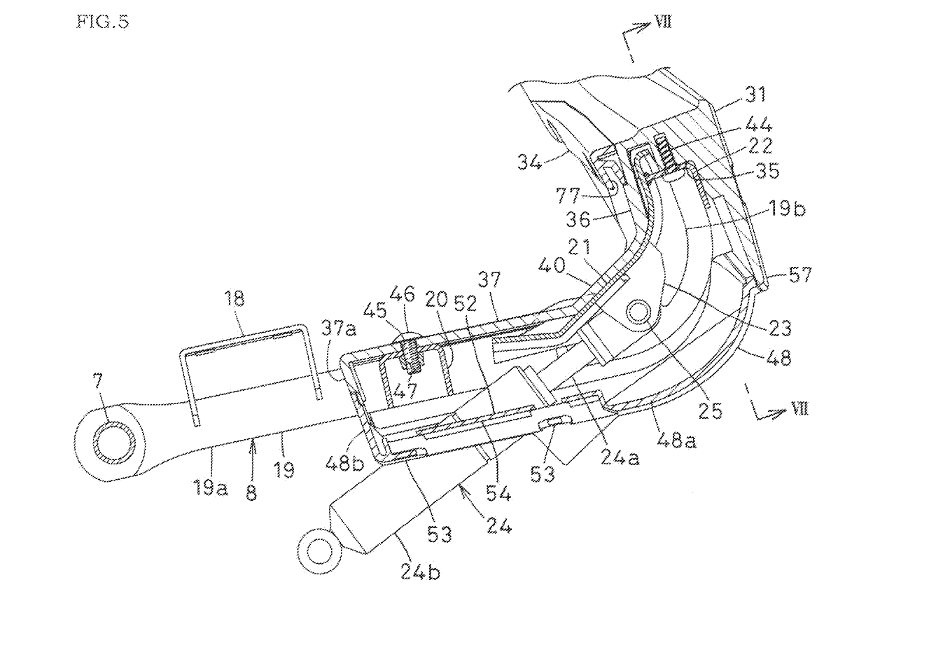

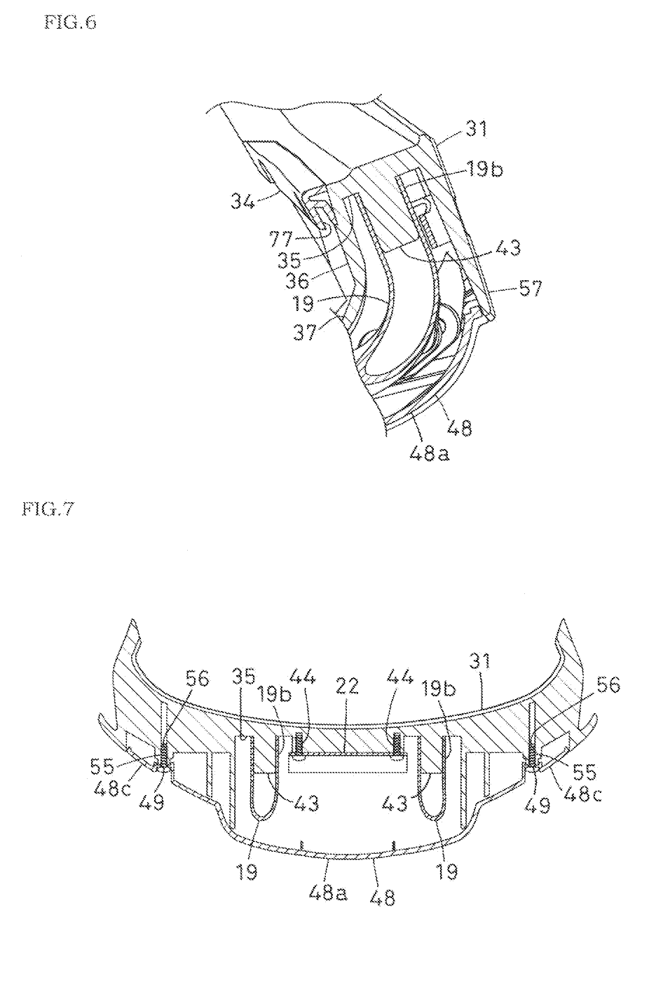

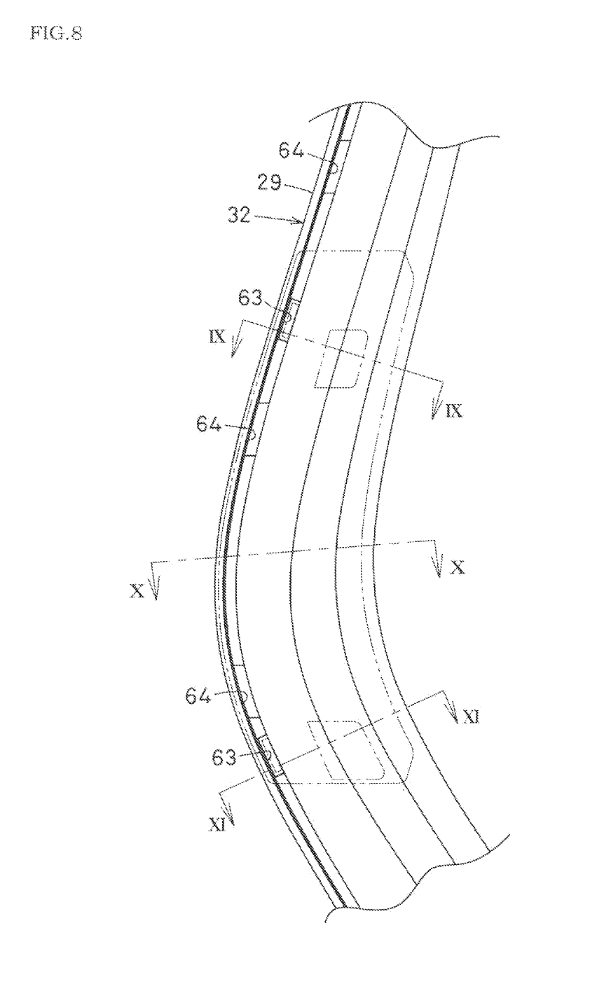

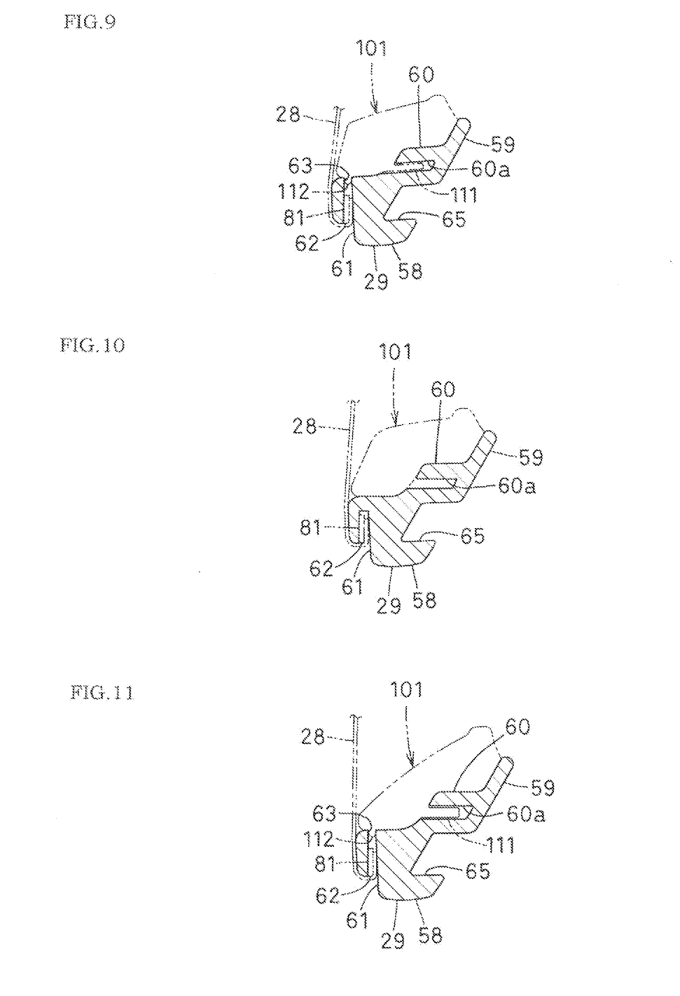

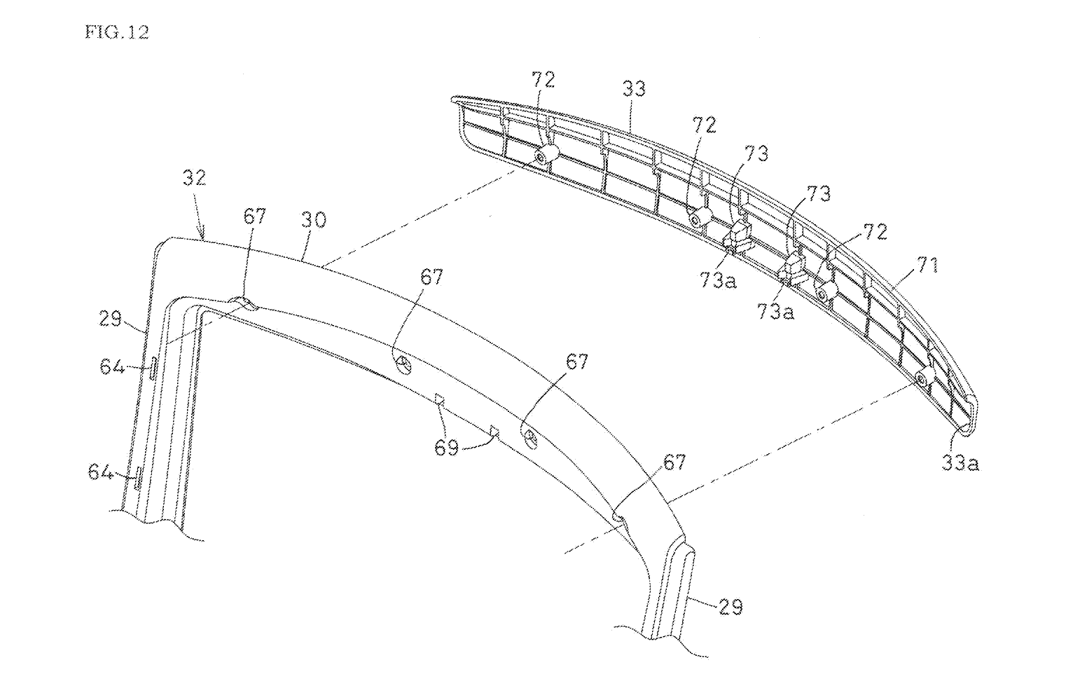

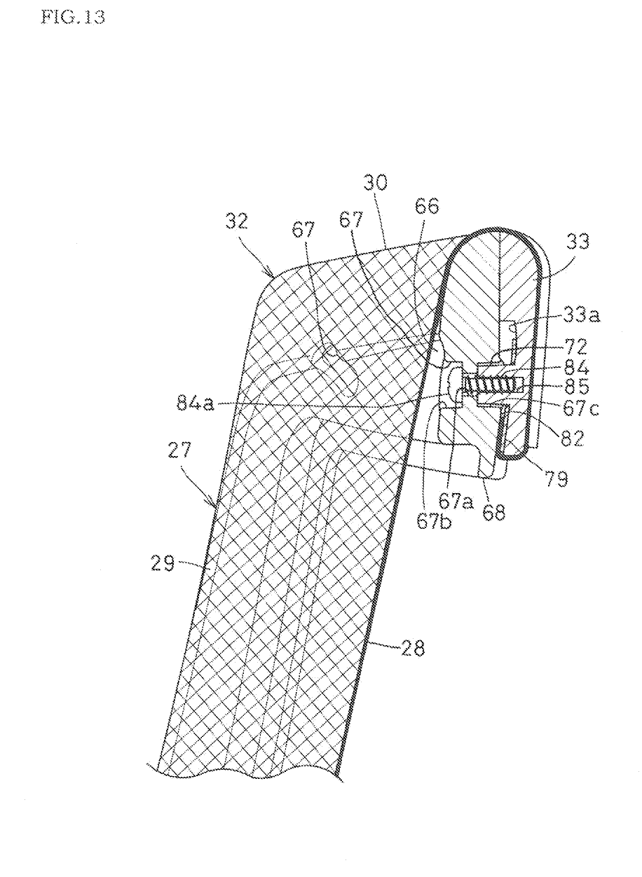

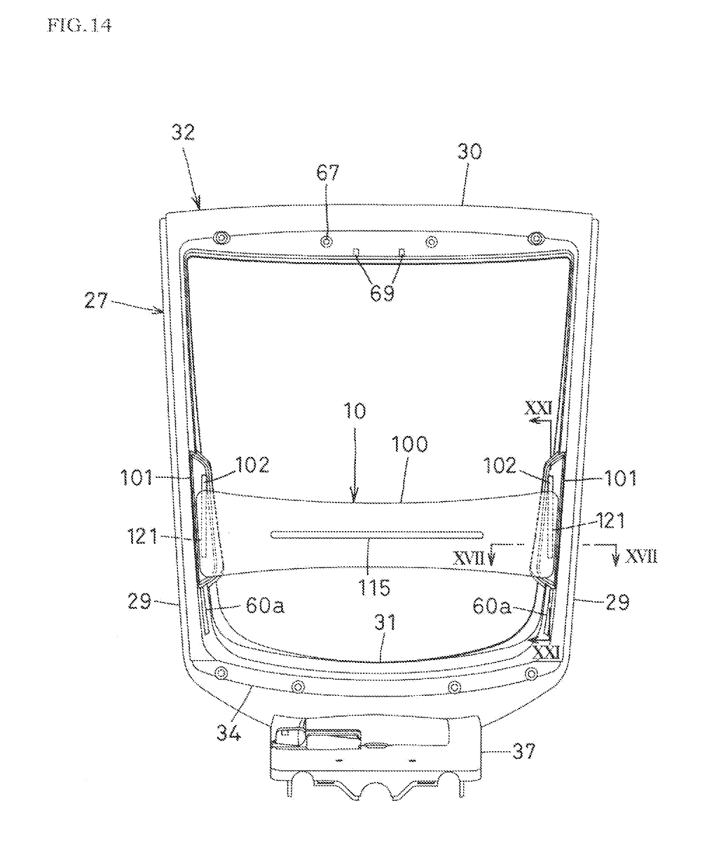

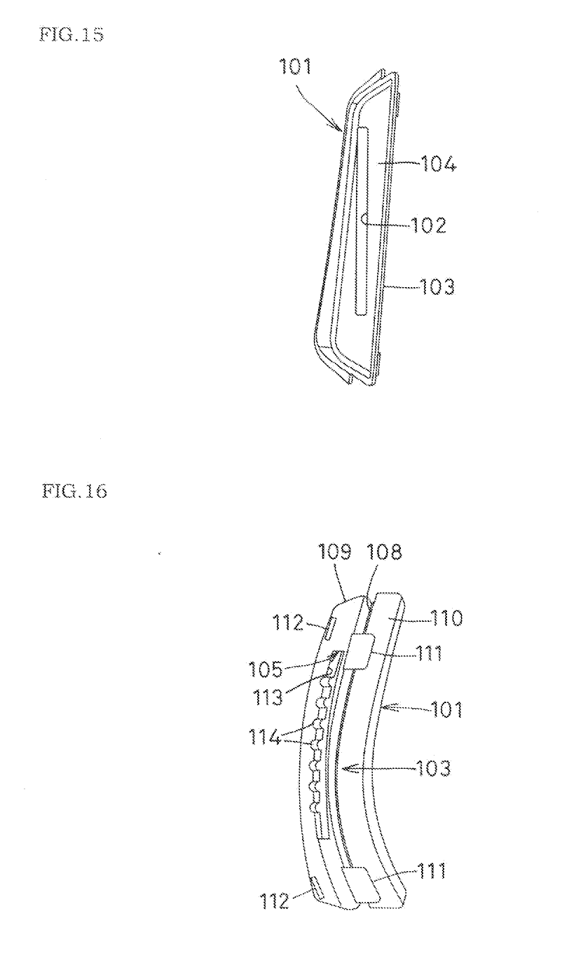

FIG. 13 is a vertical sectional side view taken along the line XIII-XIII in FIG. 1;

FIG. 14 is a front elevational view of a back frame to which a lumbar support device is mounted without a stretched member;

FIG. 15 is a front elevational view of a right holding member;

FIG. 16 is a perspective view of the right holding member viewed from right and back;

FIG. 17 is a horizontal sectional plan view taken along the line XVII-XVII in FIG. 14;

FIG. 18 is a perspective view of a lumbar support viewed from above, front and right;

FIG. 19 is a perspective view of the lumbar support cut in the middle and viewed from back;

FIG. 20 is a perspective view of the lumbar support viewed from rear, left and front;

FIG. 21 is a vertical sectional side view taken along the line XXI-XXI in FIG. 14;

FIG. 22 is a front elevational view of the back frame to which a variation of a lumbar support device is mounted without a stretched member;

FIG. 23 is a vertical sectional side view taken along the line XXIII-XXIII in FIG. 22;

FIG. 24 is a horizontal sectional plan view taken along the line XXIV-XXIV in FIG. 22;

FIG. 25 is a horizontal sectional plan view taken along the line XXV-XXV in FIG. 22;

FIG. 26 is a perspective view of a right holding member in the lumbar support device in FIG. 22;

FIG. 27 is a perspective view of the lumbar support viewed from rear, left and front;

FIG. 28(a) is a perspective view of a support arm in a hanger device, (b) is a side view and (c) is a plan view;

FIG. 29 is an exploded perspective view of the support arm in the hanger device;

FIG. 30 is a vertical sectional side view taken along the line XXX-XXX in FIG. 28(a);

FIG. 31 is a horizontal sectional plan view taken along the line XXXI-XXXI in FIG. 28(a) when the support arm is mounted to the hanger device;

FIG. 32 is a vertical sectional side view taken along the line XXXII-XXXII in FIG. 31; and

FIG. 33 is a vertical sectional side view taken along the line XXXIII-XXXIII in FIG. 1.

### EMBODIMENTS FOR CARRYING OUT THE INVENTION

One embodiment of the present invention will be described with respect to the drawings. In each view, right and left are mentioned when viewed from the front.

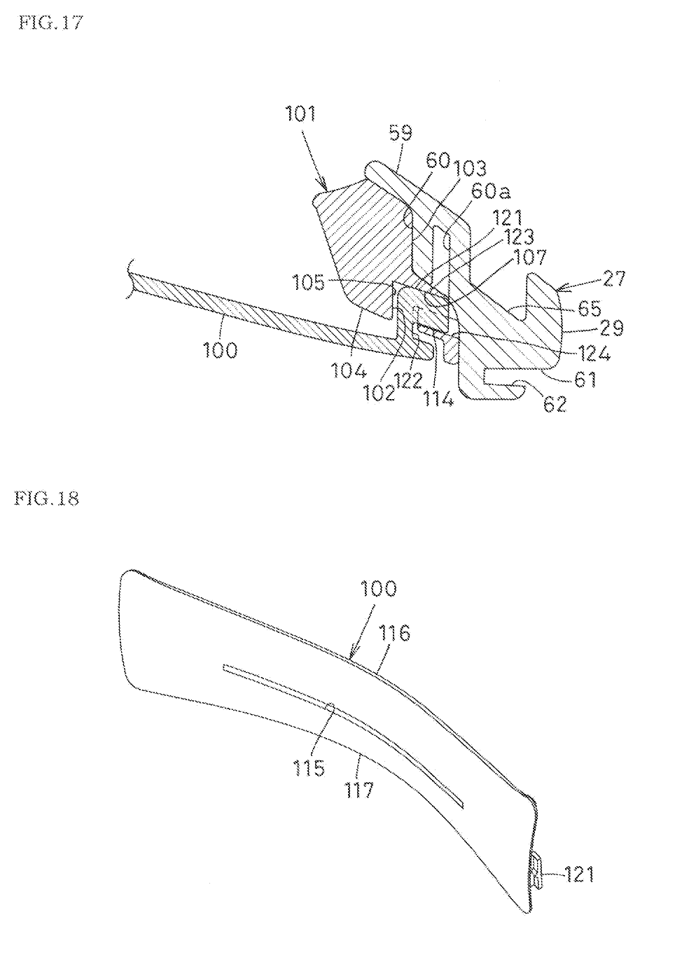

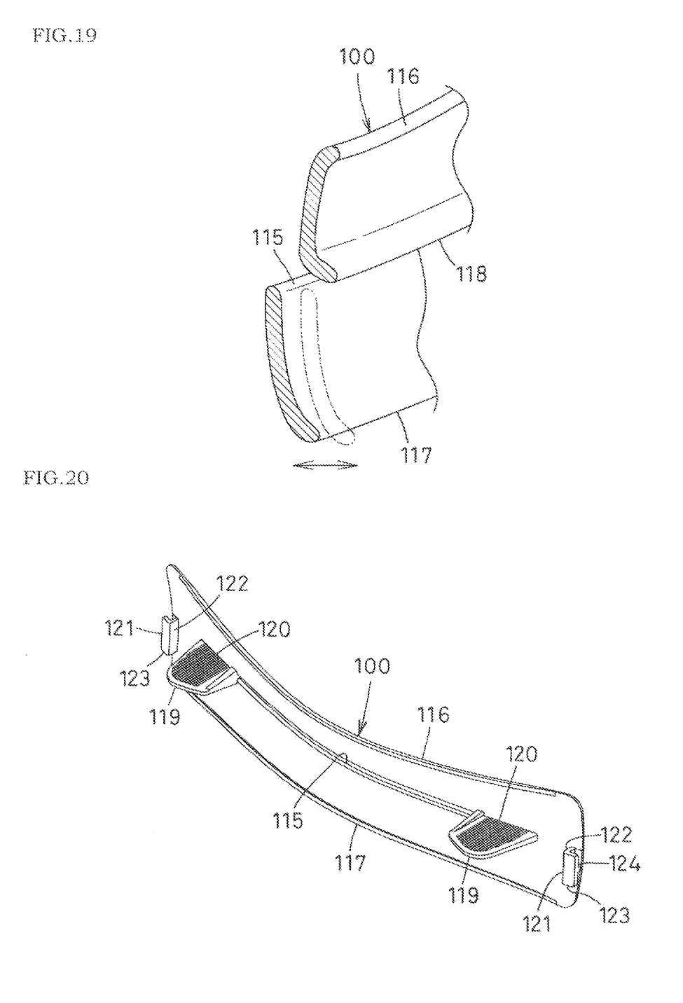

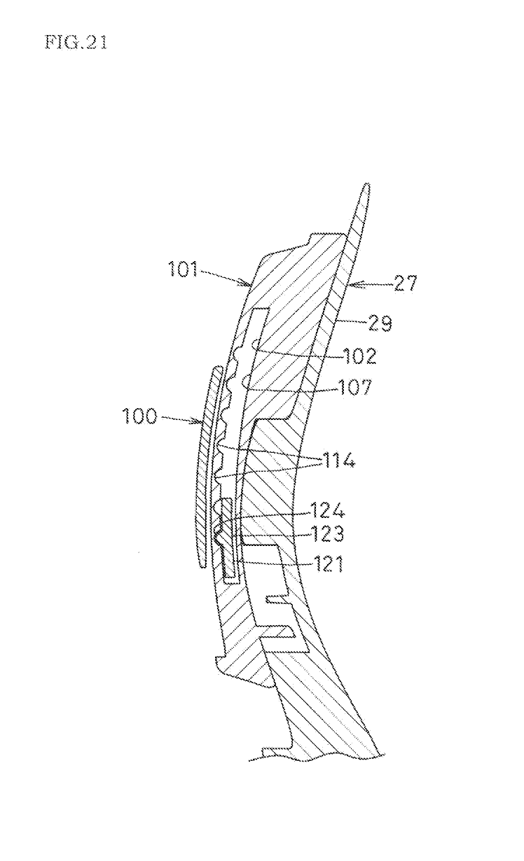

FIG. 1 is a front elevational view of a chair comprising the backrest to which a stretching structure of the present invention is applied, and FIG. 2 is a side elevational view thereof.

The chair comprises a leg unit 3 comprising five radial legs 2 each of which has a caster 1 at the end; a telescopic column 4 which stands at a center of the leg unit 3 and has a gas spring (not shown) therein; a base 5 a rear end of which is fixed to the upper end of the column 4; a seat 6 supported above the base 5 (later described); the backrest 9 supported on an upper rear part of an L-shaped backrest support frame 8 pivotally mounted to the base 5 via a transverse shaft 7 (shown in FIG. 3) at the front end; a lumbar-support device 10 in the middle of the height of the backrest 9; and a hanger device 11 located at the upper end of the backrest 9 as an optional member.

The base 5 comprises a rectangular box having an upper opening which has known biasing means for biasing the seat 6 forward anytime such as a compression spring (not shown) as disclosed in JP2005-211244A; and adjusting means (not shown) for adjusting a force of the spring. The biasing means and adjusting means do not directly relate to the present invention and their concrete structure and detailed description are omitted.

The upper opening of the base 5 is covered with a removable cover 12.

The seat 6 comprises a seat frame 13, a synthetic-resin seat plate 14 mounted to the seat frame 13; and cushion material 15 mounted to the seat plate 14 to cover an upper surface and an outer circumferential surface of the seat plate 14.

In FIG. 1, a pair of lateral rods 13a,13b is fixed at the side ends to front and rear parts of the seat frame 13. Each of the pair of lateral rods 13a,13b is inclined outward and upward and is spaced downward from the seat frame 13 in the middle.

The middle of the front lateral rod 13a is located through an elongate hole 16 formed between the upper front edge of the base 5 and the front lower edge of the cover 12 and is biased forward by the compression spring in the base 5.

The middle of the rear lateral rod 13 is pivotally mounted on a flat surface of a pair of brackets 18,18 behind the shaft 7 of a backrest support frame 8 with a pair of coupling metal tools 17,17.

When the backrest 9 is inclined backward with the backrest support frame 8 due to coupling of the backrest support frame 8 to the rear lateral rod 13b, the rear part of the seat 6 is moved backward and downward. The front lateral rod 13a is thus moved backward and downward along the elongate hole 16 against a force of the compression spring in the base 5, and the front part of the seat 6 is moved backward and downward.

A forward returning pivoting force of the backrest 9 and a forward upward returning force of the seat 6 are obtained not only by the biasing force of the compression spring in the base 5 but also by a

force of a gas spring 24 (later described).

In FIG. 3, the backrest support frame 8 comprises a pair of backrest support rods 19,19 made of a metal pipe and having a standing portion 19b at the rear end of a forward portion 19a; a U-shaped intermediate coupling member 20 connecting the forward portions 19a,19a to each other in the middle; an arcuate rear coupling member 21 coupling facing surfaces of the rear end of the forward portion 13a of the right and left backrest support rods 19,19 and standing portions 19b except the upper end; and a L-sectioned fixing portion 22 a front end of which is fixed to the rear surface of the upper end of the rear coupling member 21 for fixing a back frame 27 (later described).

The intermediate coupling member 20 is fixed to the right and left backrest support rods 19 such that the upper surface of the intermediate coupling member 20 is coplanar with the upper surface of the forward portion 19a of the right and left backrest support rods 19 The forward portions 19a of the right and left backrest support rods 19 are parallel with each other, but the standing portions 19b becomes gradually narrower upward.

The front end of each of the forward portions 19a of the right and left backrest support rods 19 is flattened into a vertical plate in which the shaft 7 as above is fixed. The shaft 7 is pivotally mounted to the upper surface of the base 5 slightly in front of the column 4 to enable the backrest support frame 8 to pivot around the shaft 7.

The pair of brackets 18 is fixed to the forward portion 19a of the right and left backrest support rods 19 between the shaft 7 and the intermediate coupling member 20 to project upward.

In FIG. 5, an inverted U-shaped bracket 23 is fixed to the middle of a back surface of an inclined surface of the rear coupling member 21. The upper end of a telescopic rod 24a of the gas spring 24 is pivotally mounted to the bracket 23 via a transverse shaft 25. The lower end of a cylinder 24b of the gas spring 24 is pivotally mounted to the lower part of the base 5 via a transverse shaft 26 in FIG. 2.

The backrest 9 attached to the backrest support frame 8 is biased forward by the gas spring 24 anytime. By compressing the gas spring 24, the backrest 9 can freely be reclined. By locking expansion/contraction of the piston rod 24a of the gas spring 24 with operation of a lever (not shown) of the base 5, the backrest 9 can be held at an optional inclined position.

The backrest 9 comprises a back frame 27 made of rigid synthetic resin and having approximately rectangular frame which gradually becomes narrower downward; and a stretched member 28 stretched over the front surface of the back frame 27. The stretched member 28 is not shown in FIG. 4.

In FIG. 3, the back frame 27 comprises a main frame portion 32 comprising a pair of dogleg side frame rods 29,29 to project forward slightly lower than the middle of its height, an arcuate upper frame rod 30 which connects the upper ends of the side frame rods 29,29 to each other and projects backward in the middle, and a lower frame rod 31 which connects the lower ends of the side frame rods 29,29 to each other like a straight line; an upper auxiliary frame member 33 fixed to the back surface of the upper frame rod 30; and a lower auxiliary frame member 34 mounted to the front surface of the lower frame rod 31.

In FIGS. 5 and 6, on the lower surface of the lower frame rod 31. there is formed an inverted U-shaped recess 35 which is open downward, over a whole width. A fixing piece 22 and an upper rear portion of the backrest support frame 8 or the standing portion 19b of the backrest support rod 19 and upper part of the rear coupling member 21 can engage in the recess 35.

In FIGS. 3 and 5, a rectangular forward portion 37 is integrally molded with the lower middle edge of a front wall 36 projecting from the front lower end of the lower frame rod 31, and is slightly inclined forward and downward. The toward portion 37 is determined in length such that the front end is positioned in the middle of the backrest support frame 8.

At the rear left part of the forward portion 37 and at the left part of the rear coupling member 21 facing it, there are formed openings 38,38 into which a rod of an operating lever of the gas spring 24 is inserted. The opening 38 of the forward portion 37 is closed by a cover 39 after the rod is inserted.

When the backrest 9 is mounted to the backrest support frame 8, the forward portion 37 acts as an upper cover for covering a rear-half upper surface behind the intermediate coupling member 20.

A bent part of the forward portion 37 is reinforced with a rib 40 projecting from the upper surface. Bending rigidity of the forward portion 37 is enhanced because a downward edge portion 37a projects from the outer circumference except the back of the forward portion 37. At right and left side portions of the front downward edge portion 37a, there are upward arcuate recesses 41,41 which can engage with the upper surface of the forward portion 19a of the right and left backrest support rods 19, and an upward arcuate clearance groove 42 in the middle of the front downward edge portion 37a to avoid contact with the gas spring 24 when the backrest 9 is inclined backward in FIG. 3.

In FIGS. 6 and 7, a pair of downward cylindrical projections 43,43 which can fit in an upper part of the standing portions 19b of the right and left backrest support rods 19 is projected from recesses 35 on a lower surface of the lower frame rod 31.

In order to mount the back frame 27 to the backrest support frame 8, in FIGS. 6 and 7, the upper rear part of the backrest support frame 8 is inserted from below into the recess 35 of the lower frame rod 31. The upper parts of the standing portions 19b,19b of the backrest support rods 19 of the backrest support frame 8 engage info the right and left downward projections 43,43 of the recess 35. The lower surface of the forward portion 37 comes in contact with the upper surface of the intermediate coupling member 20, and the upper surface of the fixing portion 22 comes in contact with the top of the recess 35. When the right and left downward projections 43,43 fit in the standing portions 19b,19b of the right and left backrest support rod 19, the backrest support frame 8 and the back frame 27 are positioned, thereby facilitating attachment thereafter.

In FIGS. 5 and 7, the fixing member 22 fixed on the rear surface of the rear connecting member 21 of the backrest support frame 8 is fixed to the middle of the recess 35 of the lower frame rod 31 with screws 44.

Bolts 46 engaged in two holes 45,45 of the forward portion 37 are engaged and tightened on two female holes 47,47 in the upper surface of the intermediate coupling member 20 of the backrest support frame 8. Hence the forward portion 37 is fixed to the upper surface of the backrest support frame 8.

Then, the lower rear surface of the backrest support frame 8 is covered with the lower cover 48 in FIG. 3. The lower cover 48 is almost the same as the forward portion 37, is rectangular and is concave. A pair of mounting portions 48c,48c each of which has a mounting hole and is directed outward and upward projects from the rear end of an upper edge 48b on the outer periphery of a bottom plate 48a. The rear end of the lower cover 48 including the right and left mounting portions 48c is engaged and positioned in the recess 35 of the lower frame rod 31 in FIGS. 5 and 7.

A U-shaped clearance groove 50 for the gas spring 24 is formed in the middle of the bottom plate 48a.

At the right and left sides of the front upward edge portion 48b, there are formed arcuate recesses 51,51 which engage with the lower surface of the forward portion 19a.

In FIGS. 3 and 5, a raised portion 52 is formed at the right side of the bottom plate 48a. So a rectangular recess 54 having a plurality of inward engagement portion 53 on the peripheral edge is formed, and a manual for the chair is housed in the recess 54.

In FIG. 5, in order to attach the lower cover 48, the rear half of the backrest support frame 9 is covered with the lower cover 48 while the lower end of the downward edge portion 37a on the outer periphery of the forward portion 37 is in contact with the upper end of the upward edge portion 48b of the lower cover 48. Thereafter, in FIG. 7, screws 55,55 inserted from below into holes 49 of the pair of mounting portions 48c engage in a pair of female holes 56,56 formed below the recess 35 of the lower frame rod 48c.

The rear part of the lower cover 48 including the mounting portions 48c is engaged in the recess 35 in the lower surface of the lower frame rod 31. In FIG. 5, the rear end of the lower cover 48 is in contact with the inner surface of the lower end of a rear wall 57 projecting from the rear end of the lower frame rod 31, so that the lower cover 48 is positioned longitudinally of the chair and can easily be mounted.

As mentioned above, the forward portion 37 is integrally molded with the lower frame rod 31 of the back frame 27 made of rigid synthetic resin and is mounted to the upper surface of the backrest support frame 8 with the screws. The fixing portion 22 of the backrest support frame 8 is mounted to the lower surface of the lower frame rod 31. Thus, the lower part of the back frame 27 can firmly be mounted to the backrest support frame 8. The forward portion 37 molded with the lower frame rod 31 is fixed on the upper surface of the backrest support frame 8. The forward portion 37 acts as a reinforcing member. The mounting portion between the backrest support frame 8 and the lower frame rod 31 is reinforced. When the occupant leans on the backrest 9, it provides high strength against rearward bending moment exerting the lower part of the backrest support frame 8 and back frame 27.

The pair of downward projections 43 which projects from the lower surface of the lower frame rod 31 engages with the pair of standing portions 19b spaced from each other transversely of the chair on the lower surface of the lower frame rod 19.

The fixing portion 22 fixed to the rear coupling member between the standing portions 19b and 19b is mounted to the lower surface of the lower frame rod 31 with the screws. The upper end of the right and left standing portions can firmly be fixed to the lower surface of the lower frame rod 31 with the fixing portion 22 while the lower part of the lower frame rod 31 is stably supported with the right and left standing portions 19b in FIG. 7.

Because of high mounting strength between the backrest support frame 8 and the back frame 8, it is not necessary to take measures for enhancing strength and bending rigidity, for example, to increase diameters of the backrest support rod 19 of the backrest support frame 8 or to increase thickness of the lower frame rod 31. Hence, the chair can be lightened and the manufacturing cost can be reduced.

The back frame 27 has a large opening. Thus, even if the lower frame rod 31 or the standing portion 19b of the backrest support rod 18 mounted thereto has not enough vertical strength, there will be no problem in mounting strength of the backrest 9.

The forward portion 37 molded with the lower frame rod 31 acts as an upper cover covering the upper surface of the backrest, support frame 8. Hence, if is not necessary to manufacture a separate upper cover or to attach to the backrest support frame 8 thereby reducing the number of parts and the steps for assembling the chair.

When the backrest support frame 9 is mounted to the backrest 9, the forward portion 37 is automatically positioned as an upper cover thereby facilitating attachment of the forward portion 37 to the backrest support frame 8.

The stretching structure of the stretched member 28 to the back frame 27 as a frame will be described as below.

In FIGS. 9-11, a side frame rod 20 comprises trapezoid-sectional basic portion 58 which becomes wider inward from the outer end; an inward projection 59 which projects inward and backward obliquely from the rear end of the basic portion 58; and a forward projection 60 which projects forward from the inward projection 59 closer to the basic portion 58.

At a corner between a front surface and an outer surface of the basic portion 58, there is formed a step 61 and an inward groove 62 along the side frame rod 29.

On the innermost end face of the inward groove 62, at two points at each side of a bent portion of the side frame rod 29, there are slits 63 each of which is open toward an inner side of the side frame rod 29, and at a plurality of points different from the two points for the slit 63, there are slits 64 each of which is open toward an inner side of the side frame rod 29 along the side frame rod 29 spaced from each other.

In the rear surface of the base portion 58, there is a groove 65 along the side frame rod 29.

In FIG. 3, there is formed a groove 65 along the side frame 29 in the middle at a lower part of each of the side frame rods 29.

In FIG. 3, under the upper frame rod 30, there is a step 66.

There are formed four female thread holes 67 in the front surface of the upper frame rod 30 at suitable intervals.

In FIG. 13, the female thread hole 67 comprises a smaller-diameter hole 67a which communicates with two larger-diameter holes 67b,67c. The larger-diameter hole 67b of the two inner holes 67 is open only at a front surface of the step 66 of the upper frame rod 30. The larger-diameter hole 67b of two female thread holes 67 closer to the right and left side ends is open over the front surface of the upper frame rod 30 and the front surface of the step 66.

At the lower end of the upper frame rod 30, there is a downward projection 68 which is continuous with the upper frame rod 30 longitudinally.

In FIGS. 3 and 4, there is formed a pair of notches 69,69 which is open forward and downward at the corner between the front surface and the lower surface of the step 66 of the upper frame rod 30. The notches 69,69 communicate with the lower end of a female thread hole 75.

The four holes 70 are formed in the front surface of the lower frame rod 31 at suitable intervals.

In FIG. 13, in the upper auxiliary frame member 33, in a base portion 71 corresponding to the back surface of the upper frame rod 30, there is formed a stepped portion 33a which is open downward. On the front surface of the stepped portion 33a, there are four bosses 72 which engage in the larger-diameter holes 67c of the female thread holes 67 in the upper frame rod 30; and a pair of inverted-T-shaped projections 73 at suitable intervals.

On the front end of the projection 73, there is formed a recess 73 which fits with a rear half of nut 76 (later described).

In FIG. 33, on the back surface of the upper frame rod 30, there is formed a groove 74 complementary with the projection 73 of the upper auxiliary frame member 33. Approximately perpendicular to the front end of the groove 74, there is formed a female thread hole 75 in the lower surface of the upper frame rod 30.

Under the groove 74 communicating with a groove 73a of the projection 73, a nut 76 is disposed to have the same axis as one of the female thread hole 75.

A lower auxiliary member 34 is a transversely-extending member which has a transverse groove 77 in the lower surface in FIG. 5. Four backward engagement pins 78 project and engage in holes 70 of the lower frame rod 31 in FIG. 3.

At the rear end of the engagement pin 78, there is provided a conical disengagement-preventing portion (not shown). Each of the engagement pin 78 has a crossed slitting (not shown). When the disengagement-preventing portion is inserted into the hole 70, it can be reduced in diameter due to its elastic deformation.

The stretched member 28 is rectangular and is made of mesh or fabric. An upper edge member 79, lower edge member 80 and side edge member 81 are attached to the upper end, lower end and each side end respectively by sewing, tacking, bonding or another attaching means.

The upper edge member 79, lower edge member 80 and side edge member 81 are made of rigid synthetic resin material as a thin plate. In the upper edge member 79, there are formed four holes 82 in which the bosses 72 of the upper auxiliary member 44 run and a pair of holes 83 complementary with the projection.

An inward projection 81a is provided on the inner side edge of each of the side edge member 81 to engage in the slit 64 of each of the side frame rod 29.

The stretched member 28 is stretched over the back frame 27 as below.

The hole 82 of the upper edge member 79 engages with the boss 72 of the upper auxiliary member 33, and the hole 83 engages with the projection 73. While the upper edge member 79 is mounted to the front surface of the upper auxiliary frame member 33, the upper auxiliary member 33 engages in the larger-diameter hole 67c of the female thread hole 67 in the upper frame rod 30, and the projection 73 engages in the groove 74. Between the front surface of the step 33a of the upper auxiliary frame member 33 and the rear surface of the upper frame rod 30, the upper edges of the upper edge member 79 and stretched member 28 are held. The stretched member 28 comes in contact with the rear surface of the upper frame rod 30. In FIG. 13, a screw 84 which passes through the hole 67 from front of the upper frame rod 30 is engaged into a thread hole 85 of the boss 72 and tightened. Thus, the stretched member 28 is firmly secured to the upper frame rod 30.

The nut 76 under the groove 74 of the upper frame rod 30 engages in the recess 73a at the front end of the projection 73 of the upper auxiliary member 33 thereby preventing rearward movement and rotation about its axis.

Furthermore, the stretched member 28 is wound on the inner circumferential surface, back surface and outer circumferential surface of the upper auxiliary frame member 33 and on the outer circumferential surface and front surface of the upper frame rod 30 in order. The stretched member 28 is moved down along the front surface of the upper frame rod 30. The lower edge member 80 secured to the lower edge and the lower edge of the stretched member 28 are engaged in the holes 70 of the engagement pins 78. The stretched member 28 is pressed into a groove 77 in the lower surface of the lower auxiliary frame member 34 formerly mounted to the front surface of the lower frame rod 31, and the stretched member 28 is stretched between the upper frame rod 30 and the lower frame rod 31.

As shown by two dotted lines in FIGS. 9-11, the stretched member 28 and a side edge member 81 mounted thereto engages in the inward groove 62 of the side frame rod 29 such that an inward projection 81a engages in the slit 64 of the side frame rod 29. The side edges of the stretched member 28 are mounted to the side frame rod 29.

The inward projection 81a which engages in the slit 64 prevents the side frame rod 29 from slipping off the stretched member 28.

The side edge of the stretched member 28 and the side edge member 81 may be mounted to the side frame rod 29 before the lower edge of the stretched member 28 and a lower edge member 80 is mounted to the lower frame rod 31.

Thus, the stretched member 28 can securely be stretched over the back frame 27 while the stretched member 28 is tightened vertically and horizontally.

Particularly, the stretched member 28 is wound on the front surface to on the outer circumferential surface and on the outer circumferential surface, the back surface and the inner circumferential surface of the upper auxiliary member 33 in order. The circumferential edge of the stretched member 28 is attached to the surface of the upper auxiliary frame member 33 which faces the back surface of the main frame member 32 thereby providing good appearance.

While the circumferential edge of the stretched member 28 is secured to the surface of the upper auxiliary frame member 33, the upper auxiliary member 33 is fixed to the back surface of the main frame member 32. Thereafter, the stretched member 28 is wound on from the inner circumferential surface to the back surface and the outer circumferential surface and on the outer circumferential surface and the front surface. The other circumferential edge of the stretched member 24a is secured to the back frame 27 by another securing means thereby stretching the stretched member 24a over the back frame 27 easily.

It is not necessary to form a groove for holding the stretched member 28 to the inner circumferential surface of the back frame 27 thereby enabling the back frame 27 to be manufactured at low cost.

The rigid upper edge member 79 is secured over the circumferential edge of the stretched member 28, and is secured over the surface of the upper auxiliary frame member 33 which faces the back surface of the main frame member 32, thereby enabling the circumferential edge of the stretched member 28 to be secured over the surface of the upper auxiliary frame member 33.

On one of the surface of the upper auxiliary frame member 33 and the upper edge member 79 facing it, the boss 72 or the projection 73 is disposed, while the holes 82,83 for preventing the upper edge member 79 from slipping off the upper auxiliary member 33 on the other of the surface of the upper auxiliary frame member 33 and the upper edge member 79, thereby positioning the upper edge portion of the stretched member 28 over the surface of the upper auxiliary frame member 33 easily and preventing the upper edge of the stretched member 28 from slipping off the upper auxiliary frame member 33 securely.

The bosses 72 and the projections 73 on the surface of the upper auxiliary frame member 33 engage in the holes 82,83 of the edge member and in the larger-diameter hole 67 of the female thread hole 67 and groove 74, thereby preventing the upper auxiliary frame member 33, upper edge member 79 and main frame member 32 from slipping off each other. Hence, such simple structure can prevent slippage between the upper auxiliary frame member 33, the upper edge member 79 and the main frame member 32.

The step 33a is formed on the surface of the upper auxiliary frame member 33 which faces the back surface of the main frame member 32, and the upper edge of the stretched member 28 and the upper edge member 79 secured thereto engage on the step 33a. When the upper auxiliary frame member 33 is fixed over the back surface of the main frame member 32, the step 33a acts as a groove formed in the inner surface of the back frame 27 thereby enabling the upper edge portion of the stretched member 28 or upper edge member secured thereto to engage in the groove. The groove can be formed without complicated and expensive die as described above, thereby reducing the manufacturing cost.

With the screws 83 through the main frame member 32 from the front surface to the back surface, the upper auxiliary frame member 33 is fixed over the main frame member 32, and the head 84a of the screw 84 is covered with the stretched member 28 stretched over the surface of the main frame member 32. The upper auxiliary frame member 33 can easily be fixed over the main frame member 32 easily, and the head 84a of the screw 84 is covered with the stretched member 28 without exposure, thereby providing good appearance.

In wasting, the stretched member 28 is stuck with a tool from front and the screws 84 are taken out. The edge of the stretched member 23 is removed from the main frame member 32 with the upper auxiliary frame member 33 thereby enabling the members to be separated and wasted.

A lumbar support device will be described. In FIG. 14, the lumbar support device 10 comprises a synthetic-resin lumbar support 100 and a pair of holding members 101 for holding the lumbar support 100 on the right and left side frame rods 29 of the backrest frame 27 of the backrest 9 to move vertically.

In FIGS. 14 and 15, the holding member 101 mounted on the side frame rod 29 of the back frame 27 becomes wider downward gradually like a block. A guide hole 102 is vertically formed in the front surface of the holding member 101.

The guide hole 102 is tilted with respect to an outer side surface 103 such that a space between the guide hole 102 and the outer side surface 103 which is in contact with the side frame rod 20 of the back frame 27 gradually becomes wider.

The inner surface of the side frame rod 29 of the back frame 27 is tilted inward and downward. When the holding member 101 is mounted to the side frame rod 29, the right and left guide holes 102,102 are in parallel with each other vertically.

In FIG. 17, the guide hole 102 has an L-section which comprises a forward hole 105 which is open in a front surface 104, and an outward hole 107 which communicates with the forward hole 105 and is open in an outward side surface 103 of the holding member 101.

In FIG. 16, a vertical groove 108 is formed in the middle of the outer side surface 103 of the holding member 101. There is a step between a front portion 109 and a rear portion 110 such that the rear portion 110 is disposed inward of the front portion 109.

At the rear edge of the front portion 109, a pair of projecting portions 111,111 is disposed to provide a gap with the rear portion 110. On the front portion 109 closer to the front edge, there is a pair of elongate projection 112 spaced from the projecting portion 111 forward.

In FIG. 17, on a front inner surface of the outward hole 107 of the guide hole 102 of the holding member 101, a plurality of grooves 114 which extends inward from an opening is spaced from each other vertically.

In order to mount the holding member 101 to the side frame rod 2 of the back frame 102, as shown in FIGS. 9 and 11, the upper and lower projections 111 of the outer side surface 103 of the holding member 101 engage in a groove 60a formed between the base portion 58 of the side frame rod 29 and the forward projection 60. The upper and lower projections 112 on the outer side surface 103 of the holding member 101 engage in the upper and lower through holes 63,63 of the side frame rod 29.

The pair of holding members 101 can be mounted to the pair of side frame rods 29 easily, securely and detachably. The lumbar support 100 is mounted to the holding members 101, thereby preventing the holding members 101 from taking off the back frame 27 inward and preventing them from moving longitudinally and vertically of the chair.

In FIG. 18, the lumbar support 100 is rectangular and is curved such that the middle in a horizontal direction projects backward, and the middle in a vertical direction projects forward.

In the upper and lower edges of the lumbar support 100, the width in the vertical direction gradually gets smaller from the side ends toward the middle. p A slit 115 which extends horizontally is formed in the lumbar support 100. The thickness of the slit 115 of the lumbar support 100 at the right and left side edges is the same as the other part, but may be larger than the other part. The length, width and position of the slit 115 may optionally be determined.

The lumbar support 100 is separated to an upper independent flexing portion 116 over the slit 115 and a lower independent flexing portion 117 under the slit 115. The upper independent flexing portion 116 differs in flexibility from the lower independent flexing portion 117 by various methods as described as below.

The upper independent flexing portion 116 may differ in flexibility from the lower independent flexing portion 117 owing to difference in vertical width, thickness or material.

In FIG. 19, a rearward rib 118 is provided at the lower edge of the upper independent flexing portion 116 to increase rigidity, while no rib is provided at the lower independent flexing portion 117 to decrease rigidity, thereby enabling difference in flexibility.

A rib may be provided on both the upper independent flexing portion 116 and the lower independent flexing portion 117. in this case, they may differ from each other in length, width and backward projecting length thereby enabling them to differ from each other in flexibility.

The lower independent flexing portion 117 is positioned forward of the upper independent flexing portion 116 at a suitable distance. Thus, the lower independent flexing portion 117 acts as a pelvis support for holding the pelvis of the occupant, and the upper independent flexing portion 116 acts as a lumbar support for holding the lumbar of the occupant.

In FIG. 20, there are working portions 119,119 for moving the lumbar support 100 vertically by the occupant at right and left side parts on the back surface. The working portions 119,119 are disposed to project backward longer than the side frame rod 29 and holding member 101 close to the side frame rod 29.

The working portion 119 is provided at the edges of the slit 115 like a flat lever, and knurling is applied to the upper and lower surfaces of the working portion to prevent slippage.

On the rear surface at the right and left side ends of the lumbar support 100, there is provided an engagement member 121 which engages in the guide hole 102 of the holding member 101 in FIG. 18 to slide vertically. The vertical width of the engagement member 121 is smaller than the vertical width of the side ends of the lumbar support 100.

The engagement member 121 is disposed at a position lower than the middle of the vertical width of the lumbar support 100.

The engagement member 121 comprises a rearward engagement portion 122 which extends backward from the back surface of the lumbar support 100; and an outward engagement portion 123 which extends outward from the rear end of the rearward engagement portion 122, and has an L-section. A forward projection 124 is provided in the middle of a front surface of the outward engagement portion 123.

In FIG. 17, the rearward engagement portion 122 and outward engagement portion 123 of the engagement portion 121 of the lumbar support 100 slide along the forward hole 105 and outward hole 107 of the guide hole 102 of the holding member 101.

In order that the rearward engagement portion 122 and outward engagement portion 123 of the engagement member 121 may enter the forward hole 105 and outward hole 107 of the guide hole 102 of the holding member 101, the rearward engagement portion 122, the outward engagement portion 123 and a part around the guide hole 102 of the holding member 101 are elastically deformed forcedly.

When the engagement member 121 engages in the guide hole 102 of the holding member 101 in FIG. 21, a projection 124 of the outward engagement portion 123 of the engagement member 121 elastically engages in any one of a plurality of engagement grooves 114 of the guide hole 102 corresponding to a vertical position of the lumbar support 100. Thus the lumbar support 100 is positioned vertically.

In FIG. 14, in order to mount the lumbar support 100 to the right and left side frame rods 29 of the back frame 27, the holding members 101 are formerly mounted to the engagement members 121 of the right and left side ends.

Then, the right and left holding members 101 are mounted to the right and left side frame rods 29 of the back frame 27 as mentioned above, the lumbar support 100 can easily be mounted to the right and left side frame rods 29 of the back frame 278 to move vertically.

After the right and left holding members 101,101 are attached with the lumbar support 100 on the inner side of the back frame 27, the lumbar support 100 prevents the right and left holding members 101,101 from moving inward, thereby preventing each of the holding members 101 from failing off the side frame rod 29.

In FIG. 1, the lumbar support 100 is attached behind the stretched member 28 stretched over the front surface of the back frame 27. The stretched member 28 prevents the lumbar support 100 and holding members 101 from moving forward, thereby preventing the holding members 101 from falling off the side frame rod 29.

In order that the occupant may adjust a vertical position of the lumbar support 100, two arms of the occupant turn behind the backrest 9. By actuating the right and left working portions 119 of the lumbar support 100, the lumbar support 100 is moved vertically, and the projection 124 of the engagement member 121 elastically engages in any one of the plurality of grooves 114 of the holding member 101, thereby enabling the lumbar support 100 to be held at an optional position. Thus, the lumbar support 100 does not vertically move accidentally.

FIGS. 22-27 illustrate a variation of a lumbar support device. The lumbar support device 150 is different from the above lumbar support device 10 in an engagement state of the guide hole 153 of the holding member 152 with the engagement member 165 of the lumbar support 151 and in positioning of the lumbar support 151.

The same numerals are allotted to the same elements as those about the lumbar support device 10, and detailed description thereof is omitted.

In FIG. 22, the lumbar support device 150 comprises a lumbar support 151 and a pair of holding members 152 which holds the lumbar support 151 on the inner surface of the right and left side frame rods 29 of the backrest frame 27.

In FIG. 24, when the holding member 152 is attached to the side frame rod 29, a guide hole 153 of the holding member 152 comprises a forward hole 155 which is formed between the inner surface of the side frame rod 29 and a groove in the outer side surface of the holding member 152 and is open toward a front surface 154 of the holding member 152, and an inward hole 156 which is recessed inward of the rear end of the forward hole 155. The guide hole 153 has an L-shape.

In FIG. 26, a lightening hole is formed on an outer side of the holding member 152, and comprises a vertical rib 157 close to a front surface 154 and formed along the front surface 154 of the holding member 152 and a plurality of ribs 158 extending backward of a rear surface of the rib 157.

At the upper and lower ends of the vertical rib 157, there is a pair of projections 159,159 to provide a gap with the rib 158.

An outer side surface 160 faces an inner surface of a side frame rod 29 forward of the upper and lower ends of the vertical rib 157. A pair of projections 160a is spaced from the projection 159 on the outer side surface 160.

A plurality of recesses 161 is spaced from each other on the front surface 154 of the holding member 152.

In order to mount the holding member 152 to the side frame rod 29 of the back frame 27, the upper and lower projections 159 of the holding member 152 engage in the groove 60a formed between the base portion 58 and the forward projection 60 of the side frame rod 29 in FIGS. 9 and 11. The projections 160a,160a of the holding member 152 engage in the upper and lower through holes 63,63 of the side frame rod 29.

In FIG. 27, the lumbar support 151 comprises an upper independent flexing portion 163 over a horizontal slit 162 and a lower independent flexing portion 164 under the slit 162.

The upper independent flexing portion 163 and lower independent flexing portion 164 have no rib 116 in the lumbar support 100. The upper independent flexing portion 163 is approximately equal to the lower independent flexing portion 164 in thickness.

On the back surface of the lumbar support 151, there are plate-like working portions 119 extending outward from the opening edge of the slit 162.

On the rear surface of the right and left side ends of the lumbar support 151, there is a pair of engagement member 165 which vertically slides along a guide hole 153 of the holding member 152 in FIG. 24. The engagement member 165 is much thicker than the side end of the lumbar support 151.

The upper and lower engagement members 165 are spaced from each other at the side end of the lumbar support 151 in the middle.

The engagement member 165 comprises a backward engagement portion 166 extending backward from the rear surface and an inward engagement portion 167 extending inward from the rear end of the backward engagement portion 166, and has an L-shape.

In FIG. 24, the backward engagement portion 166 and inward engagement portion 167 of the engagement portion 165 slide vertically along a forward hole 155 and an inward hole 156 of the holding member 152.

An arcuate guide surface 168 which is slightly raised backward is formed on the rear surface of side end of the lumbar support 151.

A projection 169 is provided from the middle of the guide surface 168 of the lumbar support 151.

When the engagement member 165 of the lumbar support 151 engages in the guide hole 153 of the holding member 152, the inward engagement portion 167 of the engagement member 165 engages in the inward hole 156 of the guide hole 153 in FIGS. 23 and 24.

In FIGS. 23 and 25, between the upper engagement member 165 and the lower engagement member 165 of the lumbar support 151, the projection 169 elastically engages in any one of the plurality of recesses 161 on the front surface of the holding member 152.

Hence, in FIG. 23, a side wall 170 in front of the inward hole 156 of the holding member 152 is held at three points with the upper and lower engagement members 165,165 and the projection 169 between them in the middle of the side end of the lumbar support 151, thereby preventing the lumbar support 151 more effectively from loosening.

In order to mount the lumbar support 151 to the right and left side frame rod 29 of the back frame 27, the holding member 152 is formerly mounted to the engagement members 165 at the right and left side end of the lumbar support 151, and the right and left holding members 152 is mounted to the right and left side frame rods 29 of the back frame 27.

After the right and left holding members 152,152 are mounted on the back frame 27 with the lumbar support 151, the right and left projections 169 on the rear surface of the lumbar support 151 engage in the recesses 161 on the front surfaces 154 of the right and left holding members 152 Hence, the lumbar support 151 prevents the holding members 152,152 from moving inward and from falling off the side frame rod 29.

In order that the occupant may adjust a vertical position of the lumbar support 151, the lumbar support 151 is moved vertically by actuating the right and left working portions 119, and a projection 169 between the upper and lower engagement members 165 and 165 may elastically engage in any one of the plurality of recesses 161 of the holding member 152.

Then, a hanger device as an optional member will be described.

As an optional member, besides the hanger device 11, suitable members such as a headrest may be selected.

In this embodiment, the upper frame rod 30 of the backrest 9 and the upper auxiliary frame member 33 fixed to the back surface thereof constitute a connecting rod 22 connecting the right and left side frame rods 29 and 29, and the hanger divece 11 is mounted to the connecting rod 220, The connecting rod 220 may be a single member connecting the right and left side frame rods 29,20 to each other in the middle.

The hanger device 11 is mounted to the upper frame rod 30 via a support arm 230.

The hanger device 11 comprises a hanger body 212, and a pair of support rods 211 extending downward from the hanger body 212. The support rod 211 fits in a support hole 234a of a support portion 234 (later described) of the support arm 230. Thus, the hanger device 11 vertically slides.

The hanger body 212 has a width enough to put a jacket on. The hanger body 212 has an inverted-U shape viewed from the side, and an inverted triangle viewed from the back.

The support rod 211 comprises a vertical rod portion 211a; an extending rod portion 211b which becomes wider to the other extending rod portion 211b upward from the upper end of the vertical rod portion 211a when the support rod 211 moves downward to a lower-limit engagement portion, and a connecting portion 211c curved to come closer downward from the lower end of the vertical rod portion 211a when the support rod 211 moves upward to an upper limit engagement portion. The support rods 211 are connected to each other at the lower end of the connecting end 211c.

As shown in a perspective view, a side view and a front view in FIG. 28 (a), (b), (c) respectively, the support arm 230 comprises a rectangular thick plate in which a tilted portion 233 is provided from the rear end of a base portion 232 which has an upward projection 231 at the front end. At the rear end of the tilted portion 233, there is formed a support portion 234 for supporting the support rod 211 of the hanger device 11. A pair of holes 231a is formed on the upward projection 231, and a pair of support holes 234a is formed at the right and left side ends of the support portion 234 to support the support rod 211 of the hanger device 11. The support arm 230 comprises two members divided longitudinally of the chair. FIG. 29 is an exploded perspective view of the support arm 230. A front support arm member 240 is coupled to a rear support arm member 250 with a bolt 260 and a nut 261 to constitute the support arm 230.

A rectangular groove 241 is formed in the upper part of the tilted portion 233 of the front support arm member 240. A pair of bolt-through holes 241b is formed in a back plate 241a of the groove 241. A front wall surface 242 of the support hole 234a is doglegged. A pair of nut-holding portions 251 having an upper opening is provided on the front surface of the support portion 234 of the rear support arm member 250. On the front surface of the nut-holding portion 251, there is formed a bolt-through hole 251a which has the same axis as that of the bolt-through hole 241b of the front support arm member 240.

To connect both the members 240,250, the hanger device 11 is held between the members 240 and 250 such that the support, rod 211 of the hanger device 11 is positioned in the support hole 234a formed by the two members, and a bolt 260 is put into the bolt-through holes 241b,251a. A nut 261 of a nut-holding portion 251 of the rear support arm member 250 is tightened, so that the members 240,250 are combined to form the support arm 230.

FIG. 30 is a vertical sectional side view of FIG. 28(a).

FIG. 31 is a horizontal sectional view when the support arm 230 is mounted to the hanger device 11, taken along the line XXXI-XXXI in FIG. 28(a).

FIG. 32 is a vertical sectional view taken along the line XXXII-XXXII in FIG. 28(a).

In FIG. 32, a front end face 211aa of the vertical rod portion 211a has a wave which fits the doglegged front wall end face 242 of the support hole 234a of the support arm 230.

After a vertical position of the hanger device 11 is adjusted and the front face 211 aa of the vertical rod portion 11a fits in the front wail end face 242 of the support hole 234a, the bolt 260 is held with the nut 261 and tightened. Hence, the hanger device 11 can be fixed at a vertical position.

In order to adjust it again, after the bolt is loosened, it is possible to adjust the position again easily.

In FIG. 33 which is an enlarged vertical sectional view showing attachment to the connecting rod 220 as an optional member, at a front lower portion of the connecting rod 220 of the back frame 2 or at a front lower portion of the upper frame rod 30 forming a front surface of the connecting rod 220, there is formed a step 30a behind which a downward projection 68 is provided.

The support arm 230 as an optional member is located within an inner space of the back frame 27, The upward projection 231 of the support arm 230 comes in contact with the step 30a of the upper frame rod 30 from below, and the rear surface of the upward projection 231 is in contact with the front surface of the downward projection 68 of the upper frame rod 30.

A pair of projections 73 of an inverted T-shape projects from the upper auxiliary frame member 33 fixed to the back surface of the upper frame rod 30. On the front surface of the projection 73, a recess 73a in which the nut 50 fits is formed.

On the rear surface of the upper frame rod 30, there is formed a recess 74 in which the projection 73 of the upper auxiliary frame member 33 fits. Approximately perpendicular to the front end of the recess 74, there is formed a bolt-through hole 75 in the lower surface of the upper frame rod 30. Under a recess 74 facing the recess 73a of the projection 73, a nut 76 is disposed to have the same axis as that of the bolt-through hole 75.

When the support arm 230 is disposed such that the upward projection 231 of the support arm 230 comes in contact with a step 40 of the upper frame rod 30 from below and the rear surface of the upward projection 231 is in contact with the front surface of the downward projection 68 of the upper frame rod 30, a bolt 270 is inserted into a bolt-through hole 231 of the upward projection 231 and the bolt-through hole 75 of the upper frame rod 30, and a nut 76 is tightened, so that the support arm 230 is mounted to the upper frame rod 30.

A notch 69 is formed at the lower end of the bolt-through hole 75 thereby facilitating positioning of the bolt 270. For example, where the bolt 270 passes through the bolt-through hole 231a of the support arm 230 upward, the front part of the support arm 230 is raised from below, and the bolt 270 fits in the notch 69. Thus, the support arm 230 is positioned with respect to the connecting rod 220 with the bolt 270. The holt 270 is moved slightly backward with the support arm 330, and fitted in the bolt-through hole 75 from the notch 69.

The upward projection 231 of the support arm 230 is in contact with the front surface of the downward projection 68 of the upper frame rod 30, thereby preventing the optional member from moving toward the back surface of the back frame 27.

The upper auxiliary frame member 33 is shorter than the upper frame rod 30 vertically. Thus, at the lower end of the back surface of the connecting rod 220, there is formed a back-side step 221 the lower surface of which is higher than the lower end of the downward projection 68.

The support arm 230 in which the upward projection 231 is fixed to the upper frame rod 30 extends backward and upward under the back-side step 221, but the back-side step 221 is formed. Thus, the support arm 230 does not come in contact with the stretched member 28 which is wound on the front surface to the outer circumferential surface of the main frame member 32 and the outer circumferential surface, back surface and inner circumferential surface of the upper auxiliary frame member 33 and mounted to the upper auxiliary frame member 33 in FIG. 13.

The present invention is not limited to the foregoing embodiments and various changes and modifications may be made without departing from the scope of claims.

(1) The mounting structure of the upper end of the stretched member 28 to the upper frame rod 30 of the back frame 27 may be inverted to make the mounting structure of the lower end of the stretched member 28 to the lower frame rod 31 of the back frame 27. The mounting structure of the lower end of the stretched member 28 to the lower frame rod 31 of the back frame 27 may be inverted to make the mounting structure of the upper end of the stretched member 28 to the upper frame rod 30 of the back frame 27.
(2) A projection may be formed on the back surface of the upper edge 79, and a recess may be formed on the front surface of the upper auxiliary frame member 38 facing it to engage with the projection, thereby preventing the upper edge 79 from deviating with respect to the upper auxiliary frame member 33.

### INDUSTRIAL APPLICABILITY

The foregoing embodiments relates to the backrest to which the present invention is applied. This invention is not limited thereto, But may be applied to a seat, a headrest or a screen and a partition over which a mesh is stretched of a chair.

What is claimed is:

1. The stretched structure of a stretched member that is stretched over a front surface of a frame, the frame comprising:
a main frame member in which the stretched member is in contact with the front surface of the main frame member and an auxiliary frame member fixed to a back surface of at least part of the main frame member, the stretched member being wound on from the front surface to an outer circumferential surface of the main frame member, and on an outer circumferential surface, a back surface and an inner circumferential surface portion of the auxiliary frame member in order, an circumferential edge of the stretched member being mounted to a front surface of the auxiliary frame member which faces the back surface of the main frame member.

2. The stretched structure of claim 1 wherein a rigid edge member is mounted to the circumferential edge of the stretched member, the edge member being mounted with the circumferential edge portion to the front surface of the auxiliary frame member which faces the back surface of the main frame member.

3. The stretched structure of claim 1 wherein on one of the front surface of the auxiliary frame member and the edge member which faces the front surface of the auxiliary frame member, there is formed a projection, while, on the other of the front surface of the auxiliary frame member and the edge member, there is formed a groove which engages with the projection to prevent positional displacement of the edge member to the auxiliary frame member.

4. The stretched structure of claim 3 wherein the projection on the front surface of the auxiliary frame member engages in a hole of the edge member and also in a groove on the back surface of the main frame member thereby preventing positional displacement between the auxiliary frame member, the edge member and the main frame member.

5. The stretched structure of claim 1 wherein there is formed a recessed step which is recessed backward and is open inward on the front surface of the auxiliary frame member which faces the back surface of the main frame member, a circumferential edge portion of the stretched member or the edge member mounted thereto engaging in the recessed step.

6. The stretched structure of claim 1 wherein the auxiliary frame member is fixed to the main frame member with a screw which passes through from the front surface to the back surface of the main frame member, a head of the screw being covered with the stretched member stretched over the front surface of the main frame member.
